(19) United States
(12) Patent Application Publication
(10) Pub. No.: US 2004/0057576 A1
(43) Pub. Date: Mar. 25, 2004

(54) System and method for on-demand battery backup for cable telephony device

(76) Inventors: Simon Lavaud, Suresnes (FR); Blaine Edward Ramey, Indianapolis, IN (US)

Correspondence Address: JOSEPH S.TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/252,587

(22) Filed: Sep. 23, 2002

(51) Int. Cl. H04M 1/00; H04M 9/00

(52) U.S. Cl. 379/413

(57) ABSTRACT

A system and method for providing on-demand battery backup to cable telephony devices comprising converting AC main power to DC power 102, charging a battery 104, providing regulated power to the cable modem device 106, detecting the presence of AC main power 108, providing a signal to the cable modem device to indicate that AC main power is not present 110, detecting said signal by said cable modem device 112, entering sleep mode and disabling said telephony interface 114, exiting sleep mode and enabling a telephony interface by said cable modem device upon activation of said cable telephony device 116, and signaling telephony service availability by said cable modem device 118.

### BACKGROUND OF THE INVENTION

1. Field of the Invention

The present invention relates to cable telephony, and more particularly to a system and method for on-demand battery backup of cable telephony devices.

2. Discussion of Related Art

Telephone services over cable networks, also known as Voice over Internet Protocol (“VoIP”) on cable, are susceptible to primary AC power outages because first generation cable VoIP devices are powered from the AC main and must respond to periodic polling signals from the Cable Modem Termination System (“CMTS”) in order to remain registered on the cable network.

Existing battery-backed power supplies simply work for as long as the battery can provide normal operating power to the telephony device, then turn off their output when the battery is depleted. Power conserving schemes have been proposed for the interface device to extend the backup time by putting nonessential circuitry into an idle or sleep mode during a AC main power outage. With existing Data Over Cable Service Interface Specification (“DOCSIS”) cable modem device protocols, this scheme is of limited success because the cable modem device must continue to respond to polling messages from the CMTS in order to remain registered on the cable network. The polling response requires that the most power-consuming circuits in the cable modem device remain in normal operation.

Existing commercial backup power supplies provide sufficient energy for about 10 hours of cable modem device operation (about 400 kilo Joules). In cases of extended power outages, this backup time can be exceeded and the subscriber will then lose the ability to make outgoing calls.

Therefore, a need exists for a system and method for providing on-demand battery backup to cable telephony devices.

### SUMMARY OF THE INVENTION

A system and method for providing on-demand battery backup to cable telephony devices comprising converting AC main power to DC, charging a battery, providing regulated power to the cable modem device, providing a signal to the cable modem device to indicate that AC main power is not present, and provisioning telephony service for the cable telephony device.

### BRIEF DESCRIPTION OF THE DRAWINGS

Preferred embodiments of the present invention will be described below in more detail, with reference to the accompanying drawings:

FIG. 1 is a flow chart of a method for supplying on-demand battery backup to cable telephony devices according to an embodiment of the present invention; and

FIG. 2 is a diagram of a system comprising a cable telephony device adapted to operate using on-demand battery backup according to an embodiment of the present invention.

### DETAILED DESCRIPTION

According to an embodiment of the present invention, a system and method that provides a battery-backup power supply having a converter that converts AC main power to DC, having a charger that charges a battery, having a power source that provides regulated power to the cable modem device, having a AC main power detector that detects when AC main power is not present, and having a signal provider that provides a power loss signal to the cable modem device to indicate when AC main power is not present.

The cable modem device includes a signal detector that detects the power loss signal provided to the cable modem device from the on-demand battery backup. Additionally, the cable modem device has a sleep mode circuit such as, power gating circuitry that disables selected circuitry to provide a low power consumption sleep mode. In this mode, the cable modem device does not communicate with the CMTS and does not provide data or telephony service.

The cable modem device also has wake up circuitry that exits sleep mode upon activation of a telephony device. For example, the subscriber can activate an activation switch indicating that the subscriber desires to make an outgoing telephone call. Additionally, the cable modem device has a circuit that provisions a telephony interface upon activation of a telephony device. If the activation switch is activated, the cable modem device wakes up. Wake up can occur for example, by having the power gating circuitry enable the circuitry that has been switched off and having the cable modem device initialize itself on the cable network thereby provisioning the telephony interface. This process takes approximately one minute. Additionally, the cable modem device can have a telephony service indicator that signals that telephony service is available for example, by illuminating an LED or activating an audible beep.

The cable modem device power gating circuitry also includes a first timer so that after occurrence of a main power outage, as indicated by the power loss signal from the on-demand battery backup, the cable modem device does not enter sleep mode until the first timer has elapsed. This enables the cable modem device to function normally during the short power outages that make up the majority of power interruptions. After the first timer expires, the cable modem device will enter its sleep mode and continue in that mode until it senses that the cable modem device wake up circuitry has detected that a cable telephony device has been activated. It will wake up as described previously, and will continue in normal operating mode until either a second timer expires occurring when there is no activity from attached telephony devices, an active telephone call is ended, or the battery is depleted. Upon occurrence of any of these events, the cable modem device will reenter sleep mode.

In another embodiment of the invention, the cable modem device's power gating circuitry provides power to a section of the telephony interface circuit that monitors the hook state of attached telephony devices. If a telephony device is taken off hook, the cable modem device wakes up and re-enables normal functionality of the cable telephony device. The primary advantage of this embodiment is that the subscriber can simply pick up any attached telephony device to begin the process which enables an outgoing call to be placed.

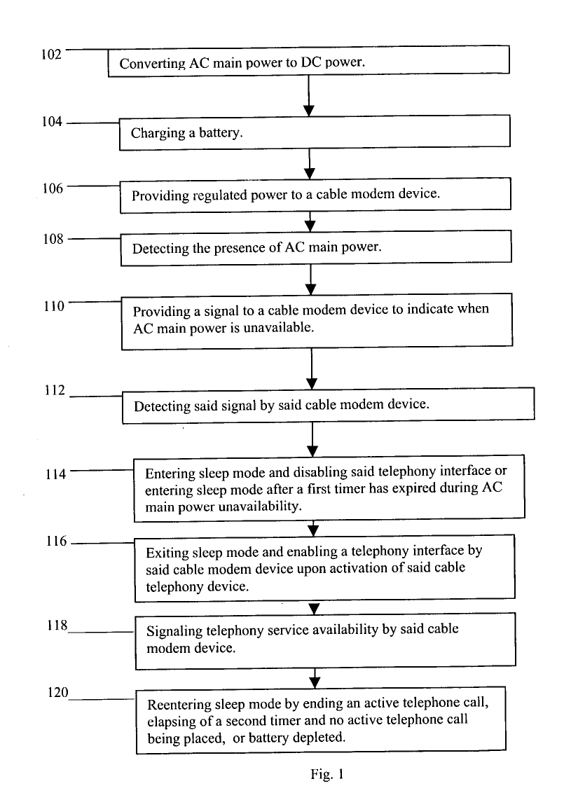

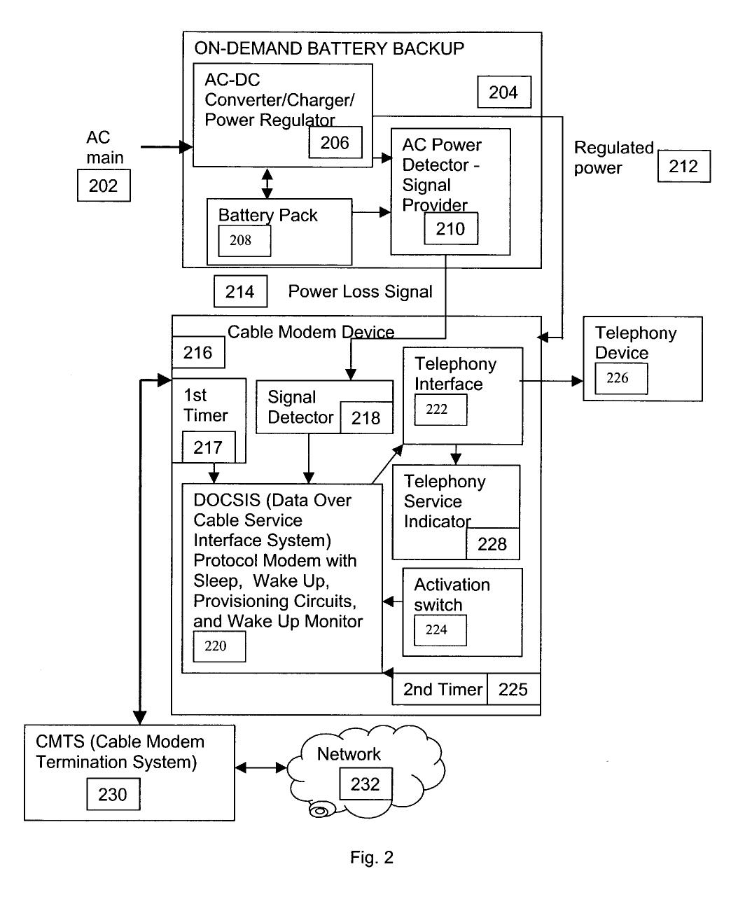

Referring to FIGS. 1 and 2, wherein FIG. 1 illustrates a method for on-demand battery backup for a cable telephony device and FIG. 2 illustrates a system for on-demand battery backup for a cable telephony device. As shown in the figures, a cable telephony device such as a telephone 226 is connected to a cable modem device 216. The cable modem device 216 is powered by an on-demand battery backup 204. The battery backup 204 is powered by AC main current 202 and has a AC/DC Converter/Charger/Power Regulator 206. The AC/DC Converter/Charger/Power Regulator 206 converts AC main power to DC power (step 102), charges the battery (step 104), and supplies regulated power (step 106) to the cable modem device 216. The on-demand battery backup has a battery pack 208 for battery power and an AC power monitor/signal provider 210 to indicate AC main power unavailability (step 108).

The on-demand battery backup 204 provides a power loss signal 214 to the signal detector 218 that indicates the absence of AC main current (step 110), e.g. during a AC main power outage. When the signal detector 218 detects (step 112) the power loss signal 214 that was generated by the on-demand battery backup 204, the DOCSIS cable modem device with sleep circuit 220 enters sleep mode (step 114), i.e. disables the telephony interface 222 thereby rendering telephone service unavailable. In the event that the AC main power outage is of short duration (step 114), the cable modem device 216 can also be equipped with a first timer 217 that prevents entering sleep mode until the first timer 217 elapses.

The cable modem device 216 is connected to a network 232 by a Cable Modem Termination System 230 to allow communications with the network 232. The cable modem device 216 uses a Data Over Cable System Interface Specification (DOCSIS) protocol 220 that has a telephony interface 222, an activation switch 224 for activating telephony service, and a telephony service indicator 228 for indicating service availability. When the activation switch 224 has been depressed, i.e. activated, sleep mode is exited and the telephony interface is enabled (step 116), thereby allowing a subscriber to place a telephone call. After the telephony service is made available, the cable modem device 216 signals telephony service availability (step 118) using a telephony service indicator 228, e.g. a LED or audible alarm.

Upon ending an active telephone call, the cable modem device 216 reenters sleep mode (step 120). The cable modem device 216 can also reenter sleep mode if the battery pack 208 is depleted (step 120) or no active telephone call is placed by a subscriber and a second timer 225 elapses (step 120).

Having described embodiments for a system and method for on-demand battery backup for cable telephony devices, it is noted that modifications and variations can be made by persons skilled in the art in light of the above teachings. It is therefore to be understood that changes may be made in the particular embodiments of the invention disclosed which are within the scope and spirit of the invention as defined by the appended claims.

What is claimed is:

1. A system for providing on-demand battery backup for cable telephony devices comprising:
an on-demand battery backup device (204) having a AC main power detector (210) for determining when AC main power is unavailable including a signal provider (210) for emitting a power loss signal (214) when AC main power is unavailable;
a cable modem device (216) coupled to said on-demand battery backup device (204) having a signal detector (218) for detecting said power loss signal (214) emitted by said signal provider (210), a sleep circuit (220) for disabling a telephony interface circuit (222) when AC main power is unavailable, an activation switch (224) for enabling said telephony interface circuit (222) when AC main power is unavailable, a telephony service indicator (228) for indicating telephone service availability when said telephony interface circuit (222) is enabled.

2. The system in claim 1, wherein said cable modem device includes a first timer (217) for initially activating said sleep circuitry during AC main power unavailability and a second timer (225) for reactivating said sleep circuitry during AC main power unavailability.

3. The system in claim 1, wherein said telephony service indicator (228) is a LED.

4. The system in claim 1, wherein said telephony service indicator (228) is an audible alarm.

5. A system for providing on-demand battery backup for cable telephony devices comprising:
means for converting AC main power to DC power (206);
means for charging a battery (206);
means for providing regulated power to a cable modem device (206);
means for detecting the presence of AC main power (210);
means for providing a signal to a cable modem device to indicate when AC main power is unavailable (210);
means for detecting said signal by said cable modem device (218);
means for entering sleep mode and disabling a telephony interface by said cable modem device (220);
means for activating a telephony device (224);
means for exiting sleep mode and enabling a telephony interface by said cable modem device upon said activation of a telephony device (220); and
means for signaling telephony service availability by said cable modem device (228).

6. The system of claim 5, wherein said means for entering sleep mode includes a means for being activated by the elapsing of a first timer (217) during AC main power unavailability.

7. The system of claim 5, further comprising means for reentering sleep mode by ending an active telephone call during AC main power unavailability.

8. The system of claim 5, further comprising means for reentering sleep mode by the elapsing of a second timer (225) and no active telephone call being placed during AC main power unavailability.

9. The system of claim 5, further comprising means for reentering sleep mode by said battery (208) being depleted during AC main power unavailability.

10. A method for providing on-demand battery backup for cable telephony devices comprising the steps of:
converting AC main power to DC power (102);
charging a battery (104);
providing regulated power to a cable modem device (106);
detecting the presence of AC main power (108);
providing a signal to a cable modem device to indicate when AC main power is unavailable (110);
detecting said signal by said cable modem device (112);
entering sleep mode (114) and disabling said telephony interface;
exiting sleep mode and enabling a telephony interface by said cable modem device upon activation of said cable telephony device (116); and
signaling telephony service availability by said cable modem device (118).

11. The method of claim 10, further comprising the step of entering said sleep mode after a first timer has elapsed during AC main power unavailability (114).

12. The method of claim 10, further comprising the step of reentering sleep mode by ending an active telephone call (120) during AC main power unavailability.

13. The method of claim 10, further comprising the step of reentering sleep mode by being activated by the elapsing of a second timer and no active telephone call being placed (120) during AC main power unavailability.

14. The method of claim 10, further comprising the step of reentering sleep mode by being activated by said battery being depleted (120) during AC main power unavailability.

15. An on-demand battery backup for cable telephony devices comprising:
an AC main power to DC power converter (206) for charging a battery, a power regulator for providng power to a cable modem device (206); and
an AC main power detector (210) for providing a signal to the cable modem device to indicate when AC main power is unavailable (210).

16. A cable telephony device comprising:
a signal detector indicating when AC power is unavailable;
means for entering sleep mode and disabling a telephony interface by said cable modem device (220);
means for activating a telephony device (224);
means for exiting sleep mode and enabling a telephony interface by said cable modem device upon said activation of a telephony device (220); and
means for signaling telephony service availability by said cable modem device (228).

17. The device of claim 16, wherein said means for entering sleep mode includes a means for being activated by the elapsing of a first timer (217) during AC main power unavailability.

18. The device of claim 16, further comprising means for reentering sleep mode by ending an active telephone call during AC main power unavailability.

19. The device of claim 16, further comprising means for reentering sleep mode by the elapsing of a second timer (225) and no active telephone call being placed during AC main power unavailability.

20. The device of claim 16, further comprising means for reentering sleep mode by said battery (208) being depleted during AC main power unavailability.
